(19) United States
(12) Patent Application Publication
(10) Pub. No.: US 2007/0097319 A1
(43) Pub. Date: May 3, 2007

(54) Stereoscopic display

(76) Inventors: Stuart McKay, Scotland (GB); Steven Mason, Scotland (GB); Gordon Mair, Scotland (GB); Colin Harrison, Scotland (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/549,949

(22) PCT Filed: Mar. 29, 2004
(86) PCT No.: PCT/GB04/01364

§ 371 Date: May 17, 2006

(30) Foreign Application Priority Data
Mar. 27, 2003 (GB) 0307077.8

(51) Int. Cl. G03B 21/00

(52) U.S. Cl. 353/7

(57) ABSTRACT

A stereoscopic display comprising a concave mirror that acts as a directional screen, a projection system including a plurality of reflecting surfaces for directing first and second images onto focusing means, and a beam splitter between the mirror and the focusing means for directing light from the focusing means towards the mirror whilst allowing light reflected from the mirror to be transmitted therethrough. In a preferred embodiment, the focusing means comprise a single lens for focusing both of the first and second images toward the concave mirror. Ideally, a tracking system is employed to detect movement of a user's head and/or eyes and move the concave mirror so that it tracks any such detected movement.

The present invention relates to a stereoscopic display and, in particular, an auto-stereoscopic desktop display incorporating a concave mirror.

Stereoscopic systems attempt to simulate natural stereoscopic vision in order to provide more life-like images. In stereoscopic vision, each eye presents the brain with a two dimensional image of an object or scene from slightly different viewpoints. These images are combined into a single three-dimensional image. In order to simulate stereoscopic vision, auto-stereoscopic systems must be arranged so that a two-dimensional image of the image source is presented separately to each eye. Each image must be from the viewpoint of the corresponding eye, so that two images are provided one for the left eye and one for the right eye of the viewer.

Most existing auto-stereoscopic systems require viewers to wear some form of special glasses. In one example, shuttered glasses are used. In this case, alternate left and right images are rapidly displayed on a viewing screen and synchronously the right and left lenses of the viewer glasses are made opaque. Thus, the viewer is presented with the left image to the left eye and a right image to the right eye. In another system, a polarising screen is placed in front of a display screen and again left and right images are rapidly alternated on the display. In this case, the orientation of the polarising filter screen is alternated, for example, orthogonally in such a manner that one orientation exists while the left image is displayed and the other when the right image is displayed. The user wears passive glasses, each lens of the glasses comprising a polarising filter one of which is orthogonally rotated relative to the other. Thus, when configured properly, again the user is presented with a left image to the left eye and a right image to the right eye.

A disadvantage of these known systems is that the viewer has to wear glasses. A further disadvantage is that they require alternating left and right images to be displayed. This effectively halves the perceived frame rate or image refresh rate and can consequently produce a faint flicker to the user, which can result in viewing discomfort. Whilst this problem can be overcome by running the display monitors at double the frame rate normally used, for example at 120 Hz, thereby to provide 60 Hz per eye, it is not ideal. A yet further disadvantage is that the glasses effectively act as a filter to reduce the amount of light reaching the eyes from the display. This means that both light and colour loss is experienced. Furthermore, the inherent inefficiency of the filters leads to cross-talk, where some of the image meant for the left eye can reach the right eye and vice versa. When the display is used for a prolonged period of time, this can lead to visual discomfort.

In order to overcome the problems associated with systems that rely on the use of glasses, various other stereoscopic arrangements have been proposed. For example, in another known display a lenticular screen is used. In this case the need for glasses is avoided because the screen breaks up the original image into a number of left and right elements. A display of this type is described in GB 2,185,825 A. A disadvantage of this is, however, that the actual horizontal image resolution is reduced in proportion to the number of views presented. Unless head tracking is used to continuously monitor observer position, and move the lenticular accordingly, pseudoscopic images may be seen (right eye sees left eye view and vice versa).

Another stereoscopic system that avoids the need for the user to wear glasses is described in U.S. Pat. No. 3,447,854. This discloses a three-dimensional viewer in which a pair of projectors direct converging left and right image beams along a co-planar axis onto a beam splitter and from there towards a concave mirror. The concave mirror acts as a directional screen and defines two exit pupils at a viewing position, so that the right and left images can be simultaneously viewed. However, whilst the image in this system can be viewed without glasses, it suffers from distortion problems, and in particular key-stoning effects. Other similar arrangements are described in U.S. Pat. No. 6,511,182 where a scanning ball lens assembly forms an image at the focus of a concave mirror in order to achieve a wide field of view and large viewing pupil infinity display, and U.S. Pat. No. 6,522,474 where a pair of concave mirrors is used in a head mounted display system. U.S. Pat. No. 4,623,223 and U.S. Pat. No. 4,799,763 illustrate the use of a concave mirror where no projection optics are used, but instead the concave mirror itself is used to form the stereo pair.

U.S. Pat. No. 4,799,763 describes yet another stereoscopic display. This uses a concave mirror to create a real image projection of two display sources, one for each eye, such that the final image resides at the radius of curvature of the mirror. These images can be viewed by a viewer located at a distance from the screen that is the same as the radius of curvature of the concave mirror. This means that the image is in fact viewed at an overall distance from the concave mirror of about twice its radius of curvature. A disadvantage of this is that the viewing area available to the user is relatively small. Another problem is that because the concave mirror is the image-forming element, this means that the quality of the concave mirror surface has a significant impact on the overall image quality. In practice, to maximise the viewing area and allow a reasonable degree of head movement, this means that the concave mirror has to be relatively large.

Yet another auto-stereoscopic display is described in U.S. 2003/0025996 A1. This provides a glasses free auto-stereoscopic viewing environment, in which an image agglomeration device (IAD) is used to project left and right eye images onto a concave mirror formed by a vacuum deformed membrane on a tensioned frame. For the specific optical arrangement of U.S. 2003/0025996 A1 to work in practice, both the IAD and the lenses have to be located at a position that is out of the line of sight of the viewer, otherwise it would not be possible for the viewer to see an image on the screen. Although it is not explicitly stated this means that the IAD cannot lie on the optical axis of the concave mirror, making the projection system off axis. Whilst U.S. 2003/0025996 A1 provides a glasses free environment, the system will suffer from image distortions, both due to the off-axis nature of the system and optical performance of the membrane mirror.

As well as the limitations described above, another problem with many known stereoscopic displays is that the viewing field is relatively limited. To overcome this problem, WO 98/43126 describes a stereoscopic system in which the image projection system can be moved in response to movement of a viewer. More specifically, WO 98/43126 discloses a display generator for generating two images that together represent a stereoscopic image, and a tracking mechanism for tracking movement of a viewer's head. The tracking mechanism is connected to a controller, which is able to control movement of the display generator. In the event that the viewer's head moves, this is detected by the tracking mechanism, which sends a signal to the controller. The controller then causes the display generator to move so that the image presented on the concave screen moves with the viewer. Whilst this arrangement allows the viewer a reasonable degree of freedom and avoids the need for glasses, it suffers from various disadvantages. Most notably, in order to ensure that the viewer can always see a good image, the image generator has to be moved. A disadvantage of this is that a relatively large space envelope is needed to accommodate this. Another display that includes a tracking mechanism is described in the article “Head Tracking Stereoscopic Display” by Schwartz CH2239-2/85/141 1985 IEEE. In this case, however, the entire display, including the projection system and the screen tracks movement of the viewer's head.

An object of the present invention is to provide an improved stereoscopic display, and in particular a display that avoids the need to wear glasses, whilst providing an improved viewing experience for the user.

According to a first aspect of the invention, there is provided a substantially on-axis stereoscopic system comprising: a concave mirror; a focusing element for focusing both of a first image and a second image towards the concave mirror, and a beam splitter between the mirror and the focusing element for directing light from the focusing element substantially along the optical axis of the mirror whilst allowing light reflected from the mirror to be transmitted therethrough.

By using a single focusing element, preferably a single lens, to focus both of the first and second images onto the screen, image quality can be dramatically improved. Using a single lens on-axis projection system eliminates keystoning, negating the need for electronic or optical correction. Since left and right eye image planes are not tilted with respect to each other there can be perfect stereo registration of images, and so image quality can be improved. Those skilled in the art will appreciate that a suitable lens system can be carefully chosen, or designed, for projection of first and second images such that no image movement occurs when the observer moves within the system exit pupil.

A plurality of focusing elements may be used, each being provided for focusing both of the first and second images towards the concave mirror. The plurality of focusing elements may be stacked along a single optical axis.

The first and second images may be provided in different planes. The first and second images may be provided in planes that are symmetrically placed relative to an axis. The first and second images may be provided in substantially parallel planes. Alternatively, first and second images may be provided in substantially perpendicular planes.

According to another aspect of the invention, there is provided a stereoscopic system comprising: a concave mirror; first and second focusing means for focusing first and second images towards the screen, the first image being positioned so that its centre is offset from an optical axis of the first focusing means and the second image being positioned so that its centre is offset from the optical axis of the second focusing means, and a beam splitter between the mirror and the first and second focusing means for directing light from the first and second focusing means towards the mirror whilst allowing light reflected from the mirror to be transmitted therethrough.

Preferably, each of the first and second images is offset by an amount so that each of the first and second image beams converge towards a geometric axis of the first and second focusing elements. Preferably, the geometric axis of the first and second focusing elements is aligned with the optical axis of the concave mirror, so that the first and second images eventually converge on the optical axis of the concave mirror. By offsetting the first and second images relative to the first and second focussing means, so that each of the first and second image beams converge on the optical axis of the optical element, effects such as keystoning and image tilt can be reduced. In a preferred embodiment, flat field distortion free projection lenses would be used with their optical axes parallel to the optical axis of the concave mirror. In another embodiment each projection system is tilted towards the geometric centre of the mirror. In this case, in order to maintain focus across the field, the Schiempflug condition should be fulfilled.

The first and second focusing means may be adapted to focus the first and second images in a viewing plane that is on or in front of or behind the optical element.

The first image source may be provided in a plane that is parallel to the optical axis of the first focusing means. In this case, the projection system may further comprise a reflector, such as a flat mirror, positioned so as to reflect light from the first image source into the first focusing means. The second image source may also be provided in a plane that is substantially parallel to the optical axis of the focusing means. In this case, the projection system may further comprise a second reflector, such as a flat mirror, positioned, so as to reflect light from the second image source into the second focusing means.

According to another aspect of the invention, there is provided a stereoscopic system comprising a movable optical element, preferably a concave mirror, that acts as a directional screen and generates a system exit pupil; a projection system for projecting first and second images towards the optical element, the first and second images being provided from first and second image sources; a tracking system for tracking movement of a viewer, and a drive for causing movement of the optical element in response to movement detected by the tracking system.

By moving the optical element in response to signals from the tracking mechanism, the position of the element can follow that of the viewer, so that an optimum view of the images can be maintained. This simple solution avoids the need for special glasses, without compromising the projection system that provides the images, and whilst providing an apparently larger viewing window for the user.

Various aspects of the invention will now be described by way of example only and with reference to the accompanying drawings, of which:

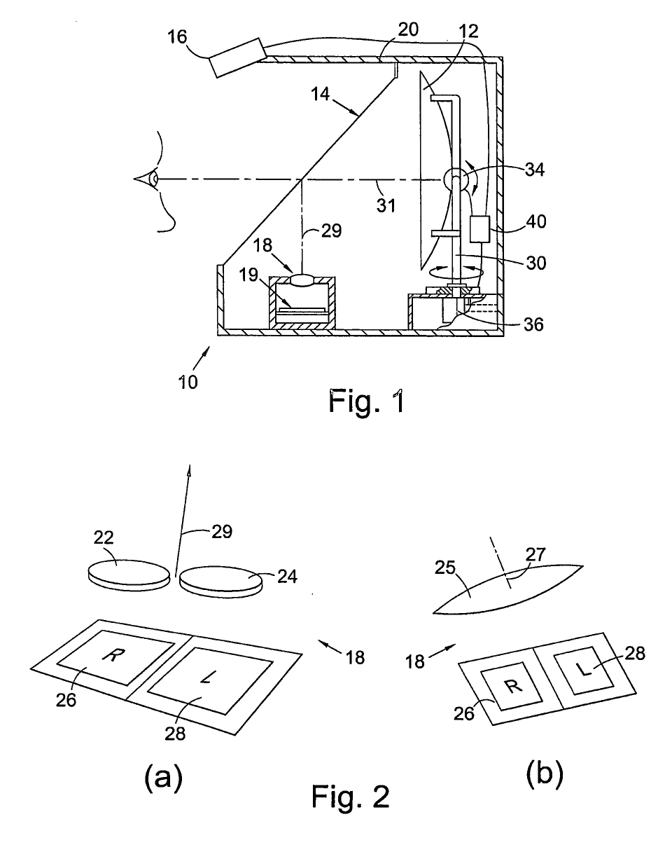

FIG. 1 is a schematic diagram of a first auto-stereoscopic system;

FIGS. 2(a) and (b) are schematic views of two image source and lens systems for use in the arrangement of FIG. 1;

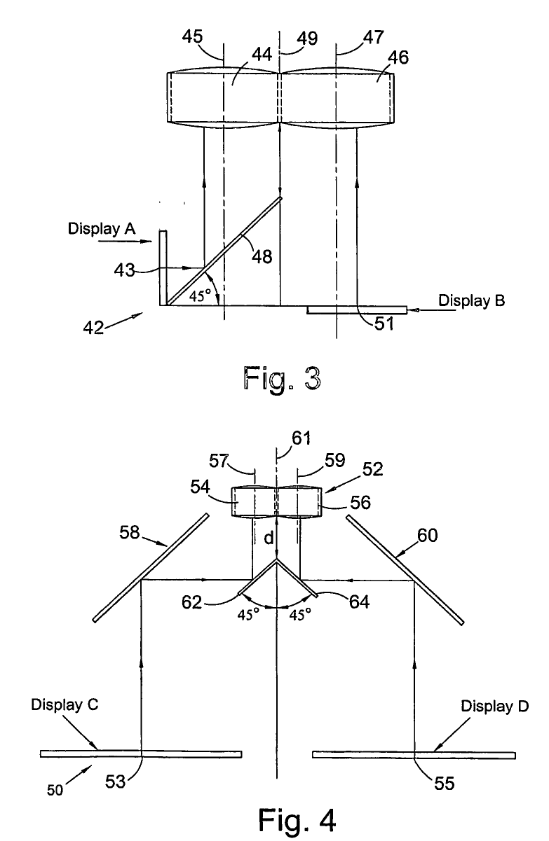

FIG. 3 is a diagrammatic representation of another image source and lens system for use in the auto-stereoscopic system of FIG. 1;

FIG. 4 is a diagrammatic representation of yet another image source and lens system for use in the auto-stereoscopic system of FIG. 1;

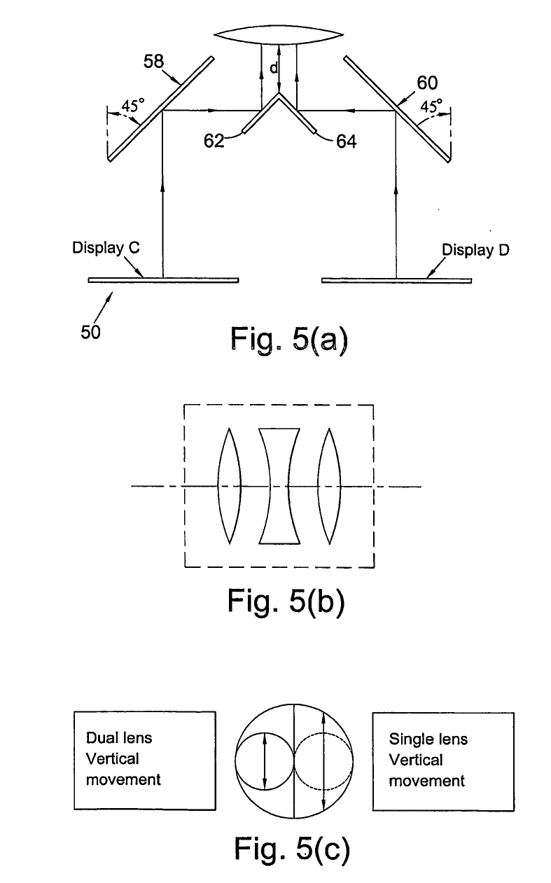

FIG. 5(a) is a diagrammatic representation of yet still another image source and lens system for use in the auto-stereoscopic system of FIG. 1, and FIG. 5(b) is a representation of an alternative lens arrangement for use in the system of FIG. 5(a);

FIG. 6 is a schematic view of a comparison between the vertical head movement that is available in the dual lens arrangement of FIGS. 3 and 4 and that of the single lens arrangement of FIG. 5;

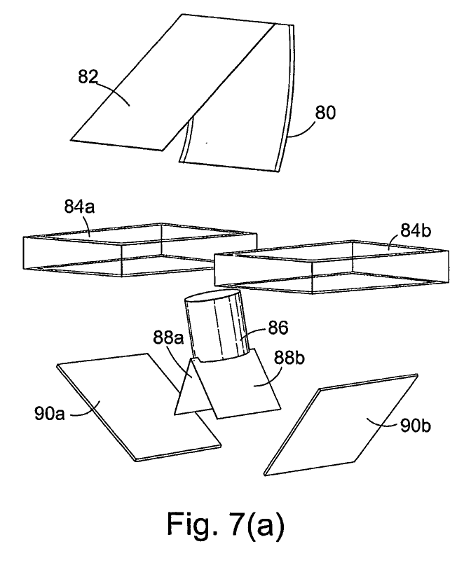

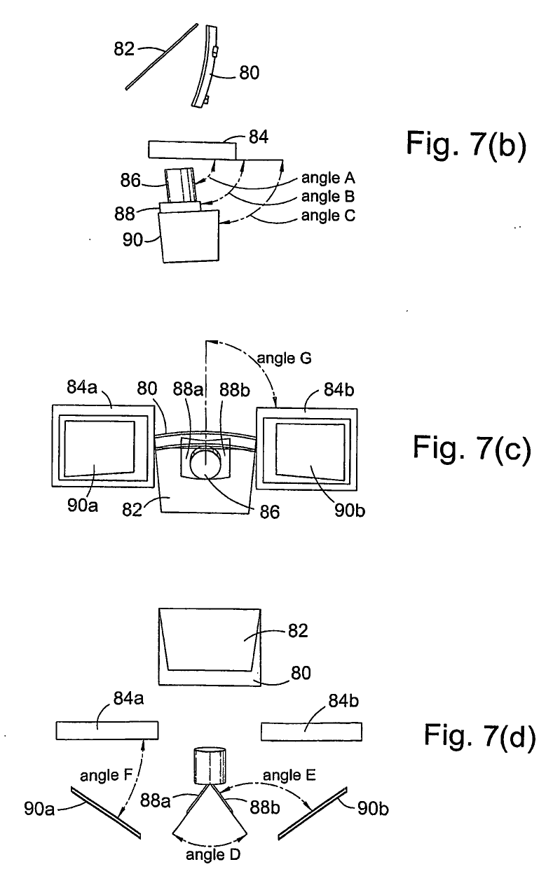

FIGS. 7(a) to (d) are diagrammatic representations of a variation of the image and lens system of FIG. 5, and

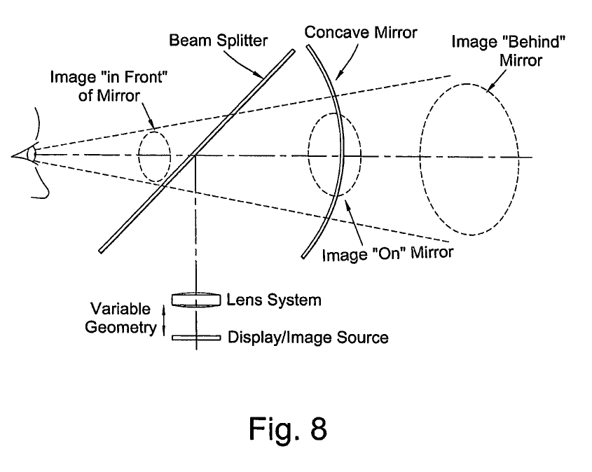

FIG. 8 is a diagrammatic representation of a modified version of the display of FIG. 1.

FIG. 1 shows an auto-stereoscopic system 10 that includes four basic sub-systems: a concave mirror 12 that acts as a directional screen; a beam splitter 14; a head-tracking device 16 and an image projection sub-system 18 for projecting images onto the concave mirror. Each of the mirror 12, the beam splitter 14 and the image projection system 18 is included in a housing 20. The concave mirror 12 is used as a directional screen and to produce an exit pupil that is formed as a real image of the projection lens assembly 18. The observer looks through this exit pupil to see the image in three dimensions, without the use of glasses.

The concave mirror 12 is located towards the rear of the housing 20, with the beam splitter 14 positioned in front of it. The beam splitter 14 is adapted so that in use at least some of the light transmitted from the image projection sub-system 18 is reflected from its surface and onto the concave surface of the mirror 12. The transmission/reflection properties of the beam splitter allow at least some of the light reflected from the concave surface 12 to be transmitted through the beam splitter so that images can be viewed by the viewer, who in practice is located on the opposing side of the beam splitter from the mirror 12. As will be appreciated, varying the transmission/reflection properties of the beam splitter determines the brightness of the images that reach the user's eyes. Ideally, the beam splitter should have a transmission/reflection ratio of 50:50. As an example, a pellicle beam splitter may be used.

Light is directed towards the beam splitter by the image projection sub-system 18. This may have single or multiple lenses. A specific example of a multiple lens system is shown in FIG. 2(a) . This has two identical lenses 22 and 24, one of these lenses 22 being positioned above a right hand image source 26 and the other 24 being positioned above a left hand image source 28. As shown, the lenses 22 and 24 lie in the same plane, although this may be changed by, for example, tilting the lenses as and when desired. The lenses 22 and 24 are spaced apart by an amount that corresponds to the average inter-ocular spacing of about 63 mm, so that the real images of the projection lenses projected by the concave mirror 12 are optically at the correct position to enter the left and right eye of the viewer, i.e. separated by an amount of the order of 63 mm.

The source images 26 and 28 could be provided side by side on a single display or provided on two separate displays. In either case, the first image 26 is positioned so that its centre is offset from an optical axis of the first lens 22. Likewise, the second image 28 is positioned so that its centre is offset from an optical axis of the second lens. The projection lens assembly 18 is itself positioned so that the geometric axis 29, that is the mid-point, of the first and second lenses is aligned with the optical axis of the concave mirror 12. Because of this, the first and second image beams eventually converge on the optical axis 31 of the concave mirror 12. By arranging the projection lens system 18 as described previously distortion effects can be reduced.

As an alternative example, FIG. 2(b) shows a single lens projection system, which has a single lens 25 positioned above and extending over each of the right and left hand image sources 26 and 28 respectively. The single lens 25 is adapted to focus light from each of the image sources to produce images that are spaced apart by an amount that corresponds to the average inter-ocular spacing of about 63 mm. As for the arrangement of FIG. 2(a), the source images 26 and 28 could be provided side by side on a single display or provided on two separate displays. The projection system of FIG. 2(b) is positioned so that the optical axis 27 of the projection lens 25 is aligned with the optical axis 31 of the concave mirror 12, and the lens 25 is located at the radius of curvature of the mirror 12.

When the projection system 18 of FIG. 2 (b) is positioned in the display of FIG. 1 as described above, the projection part of the display is essentially on-axis. This is because the optical axis 27 of the projection system is substantially aligned with the optical axis 31 of the concave mirror 12, so that light transmitted onto the beam splitter from the projection system is directed along the optical axis of the mirror, ensuring that the projected image quality is optimised. Since the viewing position is ideally along the optical axis 31 of the mirror 12, this means that the viewing position for the configuration of FIG. 1 is also on-axis. It should be noted, however, that were the concave mirror 12 of FIG. 1 to be moved from the position shown, this would not always be the case. This will be discussed in more detail later.

The location of the lens of the image projection sub-system 18 determines the position of the image that is formed. In a preferred example, the concave mirror 12 is located substantially at the image plane of each lens. In this case, the image is formed on the plane of the concave mirror 12. Alternatively, the position or focal length of the lenses could be changed so that the image is formed in front of or behind the mirror. Where lens position is changed from the preferred position at the mirror's radius of curvature, the resulting viewing position will also change. This could be advantageous where enlarged viewing windows are desired, but where only small diameter projection optics are available. Similarly, increased field of view and feeling of immersion could be achieved where the pupil is de-magnified and the observer is positioned closer to the mirror. Optically, however, the optimum position for the projection system is for the pupil to be located at the radius of curvature of the mirror. FIG. 1 illustrates the concave mirror 12 situated in front of the user, however, it will be appreciated that the mirror 12 could be located above, below or to either side of its current position by simply altering the angle of the beamsplitter and location of the projection assembly.

The concave mirror 12 is mounted on a kinematic support that has a primary support frame 30 that allows it to be rotated and a secondary support frame 32 that allows it to be tilted. Connected to the kinematic support is a drive system. This drive system includes, but is not restricted to, servomotors. One of these motors 34 is connected via a transmission system to the axes of the primary support frame and the other 36 is connected to the axes of the secondary support frame. The motors 34 and 36 are operable to steer the mirror 12 in two axes, i.e. pan and tilt, preferably about its geometric axis/centre. Connected to the motors 34 and 36 is a control system 40 that is operable to send control commands to cause activation of the motors, and thereby movement of the mirror 12.

Connected to the control system 40 for the kinematic drive system is a tracking device 16 that is operable to monitor the position of a viewer's head and feed back signals indicative of this movement to the control system 40. The head tracking may be implemented in various ways. For example, a reflective target may be provided on the system user, which target would then be tracked by an infrared transmitter- receiver system. Alternatively, a camera system coupled with image analysis software could track the position of a user's eye. In practice, the latter is preferred because it does not require the user to wear an artificial target. The tracking device of FIG. 1 is shown mounted on a front portion of the housing 20. It will be appreciated, however, that it could be located anywhere, provided there is a clear line of sight to the user.

Tracking is implemented using the control system 40. The position of, for example, the user's eyes is acquired by the head tracker 16. This position data is fed back from the tracker to the control system 40 and used as an input to a simple computer algorithm in the control system 40 that produces output information to drive the servo-motors 34 and 36, thereby to ensure that an optimum view of the image is presented to the user as he or she moves around in space. Hence, in the event that the viewer moves his head to the left, this is detected by the tracker 16 and a control signal is sent to the motors 34 and 36 to cause the concave mirror 12 to be rotated in the same direction. Likewise, if the viewer were to move their head up slightly, a control signal would be sent to the servomotors 34 and 36 to cause the concave mirror 12 to be tilted upwards. In this way, the image is moved in a manner that corresponds to movement of the viewer's head, increasing the permissible head movement in the system. This facility also would allow the image to be slaved to the user's head position such that motion parallax could be introduced. The combination of concave mirror 12, head tracking sensor, feedback control, and kinematic structure of the mirror support frame improves the comfort and ease of use of the system for a user. In particular, by providing the tracking mechanism, the user can move his or her head within reasonable limits while continuing to observe the stereo image. Hence, an enlarged viewing field is provided.

FIG. 3 shows an alternative image projection sub-system 42 for use in the auto-stereoscopic system of FIG. 1. As before, the projection lens system 46 has a first and a second lens 44 and 46 respectively for directing light into the right and left eyes of the viewer. The images are provided on two orthogonal displays, Display A and Display B. Display A is positioned so that it lies in a plane that is substantially parallel to the optical axis of the first lens 44 of the projection lens system 42. In order to ensure that the image from Display A is projected into the first lens 44, a flat mirror 48 is provided directly facing the display and along the optical axis of the first lens 44. As shown in FIG. 3, the mirror is aligned at an angle of 45° relative to the optical axis, but as will be appreciated this could be varied as and when desired. The image of Display A is positioned so that its centre 43 is offset from an optical axis 45 of the first lens 44. Display B is positioned so that it directly faces the second lens 46 and lies in a plane that is substantially perpendicular to the optical axis 47 of that second lens 46. The image of Display B is positioned so that its centre 51 is offset from the optical axis 47 of the second lens 46.

When the projection system of FIG. 3 is used in the display of FIG. 1, it is positioned so that the geometric axis 49 of the first and second lenses 44 and 46 respectively is aligned with the optical axis 31 of the concave mirror 12. Light from Display A falls on the flat mirror 48 and is reflected into the first lens 44 of the projection lens system, where it is projected towards the beam splitter. Light from Display B is transmitted directly into the second lens 46, where it is projected towards the beam splitter. Because of the offset positions of Displays A and B and the relative alignments of the geometric axis of the projection system and the optical axis of the concave mirror, the image beams eventually converge on the optical axis of the concave mirror.

FIG. 4 shows yet another image projection sub-system 50 that can be used in the system of FIG. 1. As before, the optical arrangement includes a projection lens system 52 including first and second lenses 54 and 56 respectively for directing light into the right and left eyes. The image sources, Display C and Display D, are located behind the lenses 54 and 56. Directly facing Display C is a large, flat surface mirror 58. As shown, this is positioned at an angle of 45° relative to a line perpendicular to Display C. It will be appreciated, however, that this could be varied as desired. This mirror 58 faces inward towards Display C and is sized and positioned so that the entire image on Display C can be projected onto it. Likewise, a similar flat mirror 60 is positioned opposite Display D, with this mirror facing inward towards Display D. These large mirrors 58 and 60 have reflecting surfaces that are symmetrically placed on either side of the projection lens system 52. As shown, the mirrors 58 and 60 are substantially perpendicular, but this is not essential in all implementations. As for the system of FIG. 3, the geometric centre of Display C is offset from the optical centre 57 of the first lens 54, and the geometric centre of Display D is offset from the optical centre 59 of the second lens 56, so that the images converge at the image plane.

Also provided in the system of FIG. 4 are two smaller flat mirrors 62 and 64 that are positioned on an axis that passes between the first and second lenses 54 and 56 respectively and at 45° relative thereto. It will be appreciated, however, that this specific angle of alignment is not essential and may be varied to meet particular design criteria. In the configurations shown, with the displays lying perpendicular to the geometric axis 61, each of the smaller mirrors 62 and 64 is parallel to the corresponding one of the larger mirrors 58 and 60 respectively and is positioned so that its reflecting surface faces that of the larger mirror. The smaller mirrors 62 and 64 are positioned to reflect light transmitted from the large mirrors 58 and 60 into the projection lenses 54 and 56.

When the arrangement of FIG. 4 is used in the display of FIG. 1, it is positioned so that the geometric axis 61 of the first and second lenses is aligned with the optical axis 31 of the concave mirror 12. Light from each display C and D travels towards the corresponding one of the larger mirrors 58 and 60, where it is reflected onto the corresponding one of the smaller mirrors 62 and 64 and from there into one of the lenses 54 and 56 of the projection lens system 52. These beams are then projected towards the beam splitters, where they are directed towards the concave mirror, so that they eventually converge on the optical axis 31 thereof. As will be appreciated, the degree of magnification of the image in the system of FIG. 4 is dependent on the distance of the source displays C and D from the lens assembly and the optical power of that assembly. The focal length of the lenses is selected according to the overall size of the system.

The projection lens system of FIG. 4 has been included in the arrangement of FIG. 1. Using a concave mirror having a 560 mm aperture with a 400 mm focal length and a lens combination consisting of two pairs of lenses of 800 mm and 600 mm focal length respectively, a highly effective stereoscopic system can be provided.

The projection systems described with reference to FIGS. 3 and 4 use two focusing elements, each associated with one of the images. However, in any of these a single focusing element could be used to focus both of the right and left images, as shown in FIG. 5(a). Alternatively, a plurality of such elements could be used, these being stacked along a single optical axis, as shown in FIG. 5(b). In either case, a single large exit pupil is formed, through which the observer looks, with the left eye using the left half of the lens and the right eye using the right half of the lens. In the example shown in FIG. 5(a), the single focusing element is a lens. Light from each of the right and left images is focused through a right and left part respectively of the lens. As outlined previously, using a single lens to focus both of the first and second images towards the screen can improve image quality. Further improvements can be gained by ensuring that the optical axis of the lens is aligned with that of the concave mirror, thereby to provide an on-axis system. Additionally, greater vertical head movement within the pupil can be achieved when a single lens of diameter D is used compared with two lenses of diameter D/2. This is shown in FIG. 6. For a given axial length, both lens systems have ostensibly the same lateral head movement.

FIG. 7(a) shows an isometric view of another, preferred, embodiment of a stereoscopic display that has a single lens projection system. As before, the optical assembly consists of a concave mirror 80, a beamsplitter 82, image sources 84a and 84b, projection lens 86, folding planar mirrors 88a and 88b forming an apex which bisects the projection lens 86 and larger planar folding mirrors 90a and 90b. The concave mirror 80 is again used as a directional screen and to produce an exit pupil that is formed as a real image of the projection lens 86. The observer looks through this pupil to see the image, preferably for example in three dimensions. The folding mirrors 88a, 88b, 90a and 90b redirect the light from the image sources 84a and 84b toward the projection lens 86 which sends the light toward the beamsplitter 82 which redirects some of the light toward the concave mirror 80. This light is re-directed by the concave mirror 80 toward the viewer.

In order to produce an ergonomically feasible system the folding mirrors 88a and 88b, 90a and 90b, the projection lens 86 together with the image sources 84a and 84b are at varying angles with respect to each other. FIG. 7(b) shows a side view of these Angles A, B and C all of which can be varied with respect to the image sources 84 to minimise the overall size of the optical assembly by minimising rotation of the image sources 84. FIG. 7(c) shows the plane of rotation of the image sources 84a and 84b, as depicted by Angle G, which is being compensated for. By angling the projection lens 86 slightly out toward the viewer, Angle A of FIG. 7(b), the beamsplitter 82 and concave mirror 80 are pushed forward which in turn throws the exit pupil further away from the lower half of the optical assembly. Hence, when the assembly is provided in a desktop environment, with the projection optics below the desktop, this means that leg-room for the viewer can be maximised. Additionally the concave mirror 80 and the beamsplitter 82 are angled so that the viewer has a slightly downward gaze when viewing the image so as to comply with ergonomic ideals when viewing visual display units.

The main purpose of the planar mirrors 88a and 88b is to allow image sources of virtually limitless size to be utilised. The planar mirrors create virtual images of the image sources 84a and 84b, which can overlap each other. Other systems such as described in U.S. Pat. No. 3,447,854 are limited in the size of image sources they can use due to the projectors being side by side therefore necessitating the requirement for these projectors to be small enough in size so as to match the inter-ocular spacing of the human eyes. Otherwise the image sources would have to overlap each other physically, which is impossible in practice. If the projectors did not overlap the inter-ocular spacing of the images would be so wide that only one eye at a time would be able to observe an image. Thus, no 3D image would be viewable.

The front elevation of the preferred embodiment, FIG. 7(d), depicts Angles D, E and F which again can all be varied with respect to each other by way of maximising field of view of the image sources whilst maintaining a compact optical assembly. Angle D is critical in ensuring that the entire field of view of the image sources 84a and 84b can be observed by the viewer whilst maintaining the maximum amount of head movement within the exit pupil. Preferably this angle should be less than 90°, except for very small image sources, so that the full field of view and maximum head movement can be maintained.

Due to there being a single lens used in the configuration of FIG. 6 a common optical axis is maintained for all components resulting in a fully on-axis optical assembly. Even if head tracking were to be employed, by manipulation of the concave mirror 80, due to minimal requirements for the rotation of the mirror the system would still be substantially on-axis. In this case, for a viewing distance of, say, 900 mm typically the optical mirror could be rotated by say up to 5 degrees, without a significant impact on image quality. This would give a lateral head movement of about 10-15 cm either side of the optical axis. Of course, it will be appreciated that the angle by which the mirror can be moved to accommodate the same degree of head movement would vary depending on how close the user is to the screen. To accommodate the same amount of head movement, when the user is relatively closer to the screen the angle of rotation of the mirror will be greater, whereas when the user is relatively further from the screen, the angle of rotation of the mirror would be lower.

FIG. 8 shows an on-axis system that is similar to that of FIGS. 1 and 7, except that the position of the projection lenses is variable. This means that the location of the image plane can be varied, so that the image can be made to appear in front of, on, or behind the plane of the concave mirror. This is a significant improvement over existing systems because it allows the user's eyes to more naturally accommodate and converge on the object of interest. Most conventional. 3-D displays are limited by the location of the screen. To make the image appear to come out of the screen of such a conventional display, the images are moved to each side of the screen so that the viewer's eyes have to cross slightly in order to view them. Crossing the eyes in this way causes the convergence point to lie out in front of the screen, and so the image appears to lie in this plane. This provides a 3-D effect. However, the focus point is still on the screen and so there is a mismatch between the actual focal plane and the location of the image. This can cause the viewer's eyes to strain and so stimulate headaches and other strain related symptoms. By allowing the image plane to be moved to a point in front of the screen, or indeed behind the screen, the focal point and the position at which the eyes converge can be more closely matched, so providing a more comfortable viewing experience. Of course, rather than moving the lens or lenses, the display could be provided with a range of interchangeable lenses having different optical powers, each of which could be used in the projection system as and when desired, or a zoom projection assembly could be used.

All of the systems described above allow a single viewer to view full stereoscopic images that may comprise live or recorded video, cine film, still images, or animated computer graphics and the like. These images may be provided by various means. For example, micro-display technologies could be used to provide the images, such as organic light-emitting displays (OLEDs), liquid crystal on silicon (LCOS) or high temperature poly silicon (HTPS) and digital light processing (DLP), in addition to conventional displays such as CRTs, LCDs, etc.

A skilled person will appreciate that variations of the disclosed arrangements are possible without departing from the invention. For example, in FIG. 3, the lenses 44 and 46 are shown as being spaced from the top of the mirror 48 by a finite amount d. However, ideally the separation d should be as small as possible and preferably zero in order to maximise the degree of lateral head movement for the observer. This is true for all of the projection sub-systems described herein. Also, although the display is described as being for use on a desktop, it could be provided in a dedicated viewing booth or on a mobile platform. Alternatively, the display could be miniaturised and provided in a head mountable unit, so that it could be worn. In addition, where specific angles are mentioned, it will be appreciated that these may be varied. Furthermore, the various systems could include means for electronically correcting the image to address key-stoning and distortions brought about by projecting an image onto a curved mirror surface. Also, whilst in the lens arrangements shown in FIGS. 3 and 4 show each projection system, that is both the right and left image projection systems, being positioned substantially parallel to the geometric axis of the mirror 12, in another embodiment each projection system may be physically tilted towards the geometric centre of the mirror. In this case, in order to maintain focus across the field, the Schiempflug condition should be fulfilled. Accordingly, the above description of the specific embodiment is made by way of example only and not for the purposes of limitation. It will be clear to the skilled person that minor modifications may be made without significant changes to the operation described.

1. A substantially on-axis stereoscopic system comprising: a concave mirror; a single focusing element for focusing both of a first image and a second image towards the concave mirror, and a beam splitter between the mirror and the focusing element for directing light from the focusing element substantially along the optical axis of the mirror whilst allowing light reflected from the mirror to be transmitted therethrough.

2. A system as claimed in claim 1, wherein the focusing element is adapted to focus the first and second images in a viewing plane that is on or in front of or behind the concave mirror.

3. A system as claimed in claim 1 wherein a plurality of focusing elements is provided on a common optical axis, each focusing element being in the optical path of both the first and second projected images.

4. A system as claimed in claim 1 wherein the one or more focusing elements each comprise a lens.

5. A system as claimed in claim 1 wherein the focusing element is located at the radius of curvature of the concave mirror.

6. A system as claimed in claim 1 further comprising a pair of planar mirrors positioned so as to bisect the focusing element, one of the planar mirrors being position to direct the first image toward the focusing element and the other being position to direct the second image toward the focusing element.

7. A system as claimed in claim 1, wherein one or more reflectors are provided for directing the first and second images onto the focusing element.

8. A system as claimed in claim 1 further comprising a tracking system for tracking movement of a viewer, and a drive for causing movement of only the concave mirror in response to movement detected by the tracking system.

9. A stereoscopic system comprising: a concave mirror; first and second focusing means for focusing first and second images towards the screen, the first image being positioned so that its centre is offset from the optical axis of the first focusing means and the second image being positioned so that its centre is offset from the optical axis of the second focusing means, and a beam splitter between the mirror and the first and second focusing means for directing light from the first and second focusing means towards the mirror whilst allowing light reflected from the mirror to be transmitted therethrough.

10. A system as claimed in claim 9, wherein the first and second focusing means are adapted to focus the first and second images in a viewing plane that is on or in front of or behind the concave mirror.

11. A system as claimed in claim 9, wherein one or more reflectors are provided for directing the first and second images onto the focusing means.

12. A system as claimed in claim 9 wherein a beam splitter is located on a beam path between the first and second focusing means and the concave mirror.

13. A system as claimed in claim 9 further comprising a tracking system for tracking movement of a viewer, and a drive for causing movement of the optical element in response to movement detected by the tracking system.

14. A stereoscopic system comprising a movable optical element, preferably a concave mirror, that acts as a directional screen; a projection system for projecting first and second images onto the optical element, the first and second images being provided from first and second image sources; a tracking system for tracking movement of a viewer, and a drive for causing movement of the optical element in response to movement detected by the tracking system.

15. A stereoscopic system as claimed in claim 14 wherein the projection system includes a single focusing element for focusing both of a first image and a second image towards the concave mirror, and a beam splitter between the mirror and the focusing element for directing light from the focusing element substantially along the optical axis of the mirror whilst allowing light reflected from the mirror to be transmitted therethrough.

16. A stereoscopic system as claimed in claim 14 wherein the projection system includes first and second focusing means for focusing first and second images towards the screen, the first image being positioned so that its centre is offset from the optical axis of the first focusing means and the second image being positioned so that its centre is offset from the optical axis of the second focusing means, and a beam splitter between the mirror and the first and second focusing means for directing light from the first and second focusing means towards the mirror whilst allowing light reflected from the mirror to be transmitted therethrough.

17. A stereoscopic display comprising a concave mirror that acts as a directional screen, a projection system including a plurality of reflecting surfaces for directing first and second images onto focusing means, and a beam splitter between the mirror and the focusing means for directing light from the focusing means towards the mirror whilst allowing light reflected from the mirror to be transmitted therethrough.

18. A display as claimed in claim 17, wherein the focusing means have an optical axis that is substantially aligned with the optical axis of the concave mirror, so that the display is substantially on-axis.

19. A stereoscopic system as claimed in claim 18 wherein the focusing means includes a single focusing element for focusing both of a first image and a second image towards the concave mirror.

20. A stereoscopic system as claimed in claim 17 wherein the focusing means includes first and second focusing means for focusing first and second images towards the screen, the first image being positioned so that its centre is offset from the optical axis of the first focusing means and the second image being positioned so that its centre is offset from the optical axis of the second focusing means.
